(19) United States
(12) Patent Application Publication
(10) Pub. No.: US 2026/0084435 A1
(43) Pub. Date: Mar. 26, 2026

(54) IMAGE FORMING APPARATUS CAPABLE OF SUPPRESSING GENERATION OF STREAK IMAGE WITHOUT COMPLICATING CONFIGURATION, AND ADJUSTMENT METHOD

(71) Applicant: KYOCERA Document Solutions Inc., Osaka-shi (JP)

(72) Inventors: Masaru Masuko, Osaka (JP); Hiroki Tanaka, Osaka (JP)

(21) Appl. No.: 19/335,954

(22) Filed: Sep. 22, 2025

(30) Foreign Application Priority Data
Sep. 26, 2024 (JP) 2024-167325

(51) Int. Cl. B41J 2/21

(52) U.S. Cl. CPC B41J 2/2121; B41J 2/2135; B41J 2/2146

(57) ABSTRACT

An image forming apparatus includes a first ejection portion, a second ejection portion, an acquisition processing portion, a first setting processing portion, and an adjustment processing portion. The first ejection portion includes a plurality of first nozzles. The second ejection portion includes a plurality of second nozzles. The acquisition processing portion acquires a first separation distance between a third nozzle included in an overlapping portion of the first nozzles with the second nozzles and a fourth nozzle closest to the third nozzle out of the second nozzles positioned more on a specific direction side than the third nozzle, in a width direction. The first setting processing portion sets a usage area used for ejecting ink out of the plurality of second nozzles based on the first separation distance. The adjustment processing portion adjusts an ejection amount of the ink of the third nozzle based on the first separation distance.

### INCORPORATION BY REFERENCE

This application is based upon and claims the benefit of priority from the corresponding Japanese Patent Application No. 2024-167325 filed on Sep. 26, 2024, the entire contents of which are incorporated herein by reference.

### BACKGROUND

The present disclosure relates to an image forming apparatus and an adjustment method.

There is known an inkjet image forming apparatus including a first ejection portion and a second ejection portion. The first ejection portion includes a plurality of first nozzles arranged along a width direction orthogonal to a conveying direction of a sheet, and causes ink to be ejected from each of the first nozzles. The second ejection portion includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles. In the image forming apparatus, at any position in the width direction in an overlapping portion where the plurality of first nozzles and the plurality of second nozzles overlap, the nozzle that ejects the ink is switched between the first nozzle and the second nozzle.

In the image forming apparatus, due to an attachment error of the first ejection portion and the second ejection portion or the like, a nozzle interval at a switching portion where the nozzle that ejects the ink is switched in the overlapping portion may deviate from a design value. In this case, a streak image formed along the conveying direction may be generated in an image formed on a sheet. In contrast, the image forming apparatus in which, based on a separation distance between the first nozzle and the second nozzle included in the switching portion in the width direction, an ejection amount of the ink from either one of the two nozzles included in the switching portion is reduced is known as the related art.

### SUMMARY

An image forming apparatus according to an aspect of the present disclosure includes a first ejection portion, a second ejection portion, an acquisition processing portion, a first setting processing portion, and an adjustment processing portion. The first ejection portion includes a plurality of first nozzles arranged along a width direction orthogonal to a conveying direction of a sheet, and causes ink to be ejected from each of the first nozzles. The second ejection portion includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles. The acquisition processing portion acquires a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle. The first setting processing portion sets, when the first separation distance acquired by the acquisition processing portion is equal to or larger than a predetermined threshold value, the second nozzles positioned on the specific direction side from the fourth nozzle out of the plurality of second nozzles as a usage area to be used for ejecting the ink, and sets, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area. The adjustment processing portion decreases, when the first separation distance acquired by the acquisition processing portion is equal to or larger than the threshold value, an ejection amount of the ink of either one or both of the third nozzle and the fourth nozzle based on the first separation distance, and increases, when the first separation distance is smaller than the threshold value, the ejection amount of the ink of either one or both of the third nozzle and the fifth nozzle based on a second separation distance between the third nozzle and the fifth nozzle in the width direction.

An adjustment method according to another aspect of the present disclosure is executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles, and includes an acquisition step, a setting step, and an adjustment step. The acquisition step includes acquiring a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle. The setting step includes setting, when the first separation distance acquired in the acquisition step is equal to or larger than a predetermined threshold value, the second nozzles positioned on the specific direction side from the fourth nozzle out of the plurality of second nozzles as a usage area to be used for ejecting the ink, and setting, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area. The adjustment step includes decreasing, when the first separation distance acquired in the acquisition step is equal to or larger than the threshold value, an ejection amount of the ink of either one or both of the third nozzle and the fourth nozzle based on the first separation distance, and increasing, when the first separation distance is smaller than the threshold value, the ejection amount of the ink of either one or both of the third nozzle and the fifth nozzle based on a second separation distance between the third nozzle and the fifth nozzle in the width direction.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a diagram showing configurations of an image forming portion and a conveying unit in the image forming apparatus according to the embodiment of the present disclosure;

FIG. 3 is a diagram showing a configuration in a periphery of a nozzle in the image forming apparatus according to the embodiment of the present disclosure;

FIG. 4 is a block diagram showing a system configuration of the image forming apparatus according to the embodiment of the present disclosure;

FIG. 5 is a flowchart showing an example of ejection amount adjustment processing executed in the image forming apparatus according to the embodiment of the present disclosure; and

FIG. 6 is a diagram showing an example of an overlapping area in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

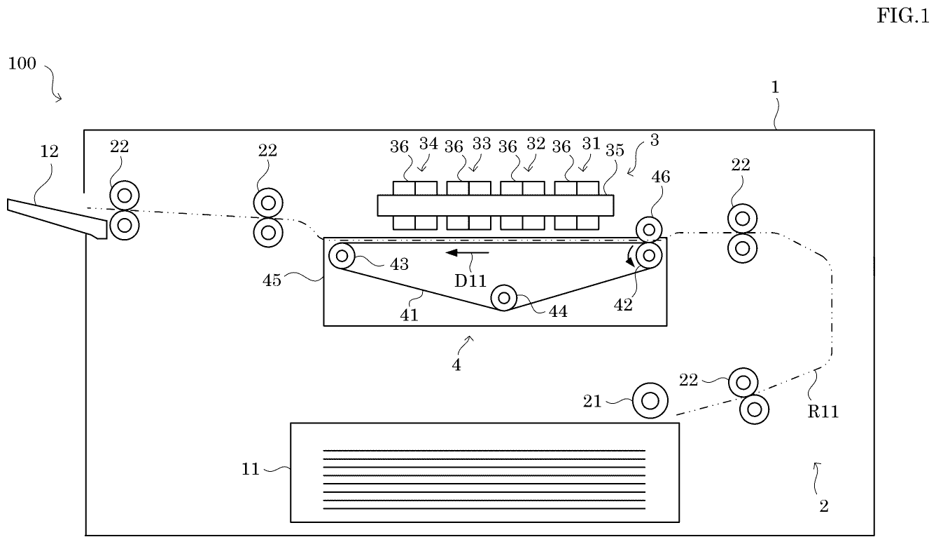

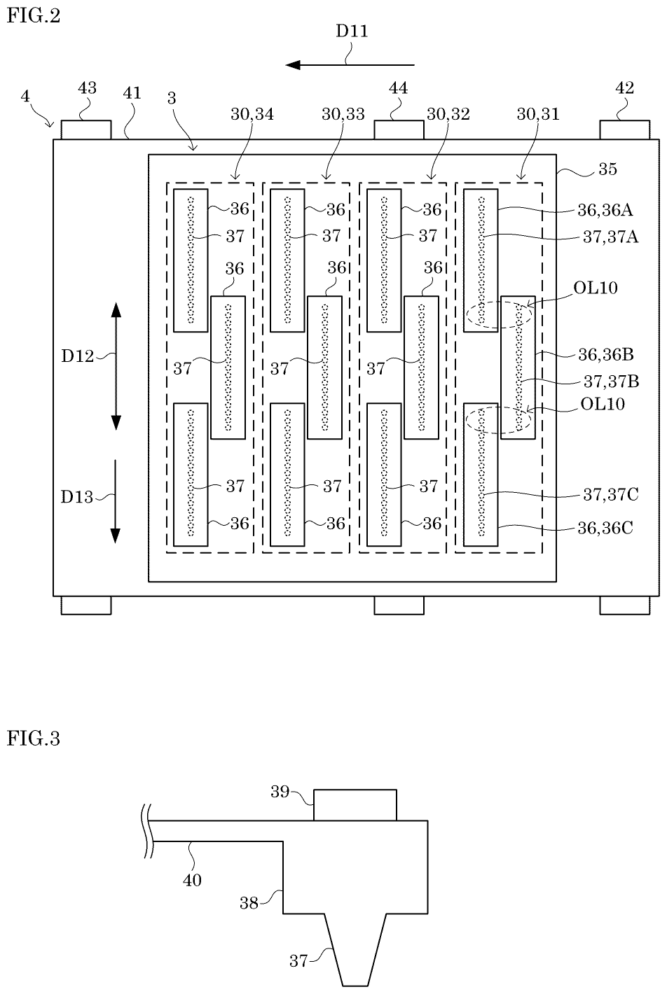

First, a configuration of an image forming apparatus 100 according to the embodiment of the present disclosure will be described with reference to FIG. 1 to FIG. 4. Herein, FIG. 1 is a cross-sectional view showing the configuration of the image forming apparatus 100. Further, FIG. 2 is a plan view showing configurations of an image forming portion 3 and a conveying unit 4. Furthermore, FIG. 3 is a cross-sectional view showing configurations of a nozzle 37, a pressure chamber 38, a piezoelectric element 39, and an individual flow path 40. It is noted that in FIG. 1, a sheet conveying path R11 is indicated by a dash-dot-dot line. Moreover, in FIG. 2, overlapping areas OL10 are indicated by broken lines.

The image forming apparatus 100 is a printer capable of forming an image on a sheet by an inkjet method. It is noted that the present disclosure may also be applied to a facsimile apparatus, a copying machine, a multifunction peripheral, and the like that are capable of forming an image on a sheet by the inkjet method.

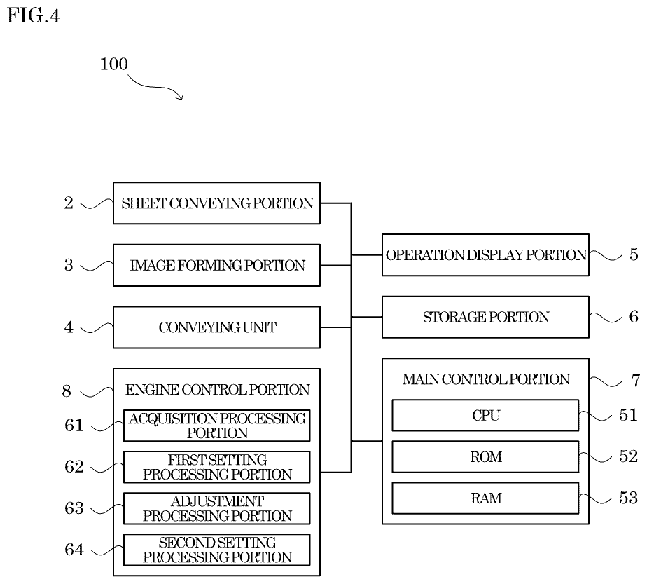

As shown in FIG. 1 and FIG. 4, the image forming apparatus 100 includes a housing 1, a sheet conveying portion 2, the image forming portion 3, the conveying unit 4, an operation display portion 5, a storage portion 6, a main control portion 7, and an engine control portion 8.

The housing 1 houses respective constituent elements of the image forming apparatus 100. A sheet feed cassette 11 (see FIG. 1) is detachably provided in the housing 1. The sheet feed cassette 11 stores sheets on which images are to be formed. A sheet discharge tray 12 (see FIG. 1) is provided on an outer side surface of the housing 1. Sheets on which images have been formed by the image forming portion 3 are discharged onto the sheet discharge tray 12. Inside the housing 1, the sheets stored in the sheet feed cassette 11 are conveyed along the sheet conveying path R11 (see FIG. 1) that passes through an image forming position by the image forming portion 3 and reaches the sheet discharge tray 12.

The sheet conveying portion 2 conveys the sheets stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 picks up an uppermost sheet in a stack of sheets stored in the sheet feed cassette 11 and feeds the sheet to the sheet conveying path R11. The plurality of conveying rollers 22 are provided while being aligned along the sheet conveying path R11. Each of the conveying rollers 22 conveys the sheet along the sheet conveying path R11. Each of the conveying rollers 22 conveys the sheet in a conveying direction D11 (see FIG. 1) directed from the sheet feed cassette 11 to the sheet discharge tray 12.

The image forming portion 3 forms an image on the sheet conveyed by the sheet conveying portion 2. As shown in FIG. 1 and FIG. 2, the image forming portion 3 includes four line heads 30 (31 to 34) and a head frame 35.

As shown in FIG. 2, each of the line heads 30 is elongated in a width direction D12 orthogonal to the conveying direction D11. Specifically, each of the line heads 30 has, in the width direction D12, a length corresponding to a width of a sheet of a largest size out of the sheets that can be stored in the sheet feed cassette 11. The four line heads 30 are provided while being aligned at regular intervals along the conveying direction D11.

As shown in FIG. 2, each of the line heads 30 includes a plurality of recording heads 36. Each of the recording heads 36 ejects ink droplets toward a sheet conveyed by the conveying unit 4. Each of the recording heads 36 provided in the line head 31 ejects black ink droplets. Each of the recording heads 36 provided in the line head 32 ejects cyan ink droplets. Each of the recording heads 36 provided in the line head 33 ejects magenta ink droplets. Each of the recording heads 36 provided in the line head 34 ejects yellow ink droplets.

Each of the recording heads 36 includes a plurality of nozzles 37 (see FIG. 2 and FIG. 3) that eject ink droplets onto a sheet. Each of the nozzles 37 is provided on a surface of the recording head 36 that opposes a sheet conveyed by the conveying unit 4. For example, in the image forming apparatus 100, small-size, medium-size, or large-size ink droplets are ejected from the nozzles 37.

Each of the recording heads 36 also includes pressure chambers 38 (see FIG. 3), piezoelectric elements 39 (see FIG. 3), and individual flow paths 40 (see FIG. 3) that respectively correspond to the nozzles 37. The pressure chamber 38 communicates with the nozzle 37 and stores ink therein. The piezoelectric element 39 varies a pressure in the pressure chamber 38 according to an input of a drive signal, to thus cause the ink droplets to be ejected from the nozzle 37. The individual flow path 40 is an ink flow path provided between the pressure chamber 38 and a common flow path (not shown) common to the plurality of nozzles 37. Connected to the common flow path are the plurality of individual flow paths 40 respectively corresponding to the plurality of nozzles 37. The common flow path is connected to an ink supply portion (not shown) that supplies ink to each of the pressure chambers 38.

As shown in FIG. 2, the line head 31 includes three recording heads 36 (36A, 36B, and 36C).

The recording head 36A includes a plurality of nozzles 37A (see FIG. 2) arranged along the width direction D12 orthogonal to the conveying direction D11, and causes ink to be ejected from each of the nozzles 37A. The recording head 36B includes a plurality of nozzles 37B (see FIG. 2) arranged along the width direction D12, and causes ink to be ejected from each of the nozzles 37B. The recording head 36C includes a plurality of nozzles 37C (see FIG. 2) arranged along the width direction D12, and causes ink to be ejected from each of the nozzles 37C.

The three recording heads 36 included in the line head 31 are arranged in a staggered pattern along the width direction D12.

Specifically, as shown in FIG. 2, the recording head 36B is arranged such that some of the plurality of nozzles 37B overlap with some of the plurality of nozzles 37A in the width direction D12 at a position that is more on a specific direction D13 (see FIG. 2) side along the width direction D12 than the recording head 36A. Also, the recording head 36C is arranged such that some of the plurality of nozzles 37C overlap with some of the plurality of nozzles 37B in the width direction D12 at a position that is more on the specific direction D13 side than the recording head 36B. In the present specification, overlapping areas between the plurality of nozzles 37 included in any one of the three recording heads 36 and the plurality of nozzles 37 included in the other recording heads 36 in the width direction D12 will each be referred to as an “overlapping area OL10” (see FIG. 2). The recording head 36A is an example of a first ejection portion according to the present disclosure. Further, the nozzles 37A are an example of first nozzles according to the present disclosure. Furthermore, the recording head 36B is an example of a second ejection portion according to the present disclosure. Moreover, the nozzles 37B are an example of second nozzles according to the present disclosure.

The line heads 32 to 34 each include three recording heads 36 arranged in a manner similar to that of the line head 31.

It is noted that the number of recording heads 36 to be provided in each of the line head 30 does not need to be limited to three.

The head frame 35 supports the four line heads 30. The head frame 35 is supported by the housing 1. It is noted that the number of line heads 30 to be provided in the image forming portion 3 does not need to be limited to four.

As shown in FIG. 1, the conveying unit 4 is arranged below the four line heads 30. The conveying unit 4 conveys a sheet while causing the sheet to oppose the recording heads 36. As shown in FIG. 1, the conveying unit 4 includes a conveying belt 41 on which a sheet is placed, a first tension roller 42, a second tension roller 43, and a third tension roller 44 across which the conveying belt 41 is stretched, and a conveying frame 45 that supports them. It is noted that a gap between the conveying belt 41 and the recording heads 36 is adjusted so that a gap between a surface of the sheet and the recording heads 36 during image formation becomes a predetermined distance (for example, 1 mm).

The first tension roller 42 is rotationally driven by a rotational driving force supplied from a motor (not shown). Thus, the conveying belt 41 rotates in a direction in which the sheet can be conveyed in the conveying direction D11 (see FIG. 1). It is noted that the conveying unit 4 is also provided with a suction unit (not shown) or the like that sucks air from a large number of through-holes formed in the conveying belt 41 in order to cause the sheet to stick to the conveying belt 41. Further, a pressure roller 46 for conveying the sheet while pressing the sheet against the conveying belt 41 is provided above the first tension roller 42.

The operation display portion 5 includes a display portion such as a liquid crystal display that displays various types of information in response to control instructions from the main control portion 7 and an operation portion such as an operation key or a touch panel that is used to input various types of information to the main control portion 7 according to user operations.

The storage portion 6 is a non-volatile storage device. For example, the storage portion 6 is a non-volatile memory such as a flash memory.

The main control portion 7 collectively controls the image forming apparatus 100. As shown in FIG. 4, the main control portion 7 includes a CPU 51, a ROM 52, and a RAM 53. The CPU 51 is a processor that executes various types of arithmetic processing. The ROM 52 is a non-volatile storage device in which information such as control programs for causing the CPU 51 to execute various types of processing is stored in advance. The RAM 53 is a volatile or non-volatile storage device that is used as a temporary storage memory (working area) for the various types of processing to be executed by the CPU 51. The CPU 51 executes the various control programs stored in advance in the ROM 52 to collectively control the image forming apparatus 100.

The engine control portion 8 controls the sheet conveying portion 2, the image forming portion 3, and the conveying unit 4. For example, the engine control portion 8 is constituted of an electronic circuit such as an integrated circuit (ASIC, DSP).

In the image forming apparatus 100, at any position in the width direction D12 in the overlapping area OL10 where the plurality of nozzles 37A and the plurality of nozzles 37B overlap, the nozzle 37 that ejects ink is switched between the nozzle 37A and the nozzle 37B.

Herein, in the image forming apparatus 100, a nozzle interval at a switching portion where the nozzle 37 that ejects ink is switched in the overlapping area OL10 may deviate from a design value due to an attachment error of the recording head 36A and the recording head 36B, or the like. In this case, a streak image formed along the conveying direction D11 may be generated in an image formed on a sheet. In contrast, the image forming apparatus in which, based on a separation distance between the nozzle 37A and the nozzle 37B included in the switching portion in the width direction D12, an ejection amount of the ink of either one of the two nozzles 37 included in the switching portion is reduced is known as the related art.

However, in the image forming apparatus according to the related art described above, in preparation for a case where a deviation amount of the separation distance between the two nozzles 37 included in the switching portion in the width direction D12 from the design value is excessively large, there is a need to provide a function of reducing the ejection amount of the ink of either of the two nozzles 37 included in the switching portion to be excessively small. This complicates the configuration of the image forming apparatus. Furthermore, when the ejection amount of the ink of either of the two nozzles 37 included in the switching portion is reduced to be excessively small, a variation from an original droplet amount is large, which causes a sense of discomfort in a print image to thus lower image quality of the image formed on the sheet.

In contrast, in the image forming apparatus 100 according to the embodiment of the present disclosure, it is possible to suppress generation of a streak image without complicating the configuration as will be described below.

Specifically, the engine control portion 8 includes an acquisition processing portion 61, a first setting processing portion 62, an adjustment processing portion 63, and a second setting processing portion 64 shown in FIG. 4.

It is noted that the main control portion 7 may include the respective processing portions described above instead of the engine control portion 8. Specifically, the CPU 51 of the main control portion 7 may execute the control programs stored in advance in the ROM 52 to function as the respective processing portions described.

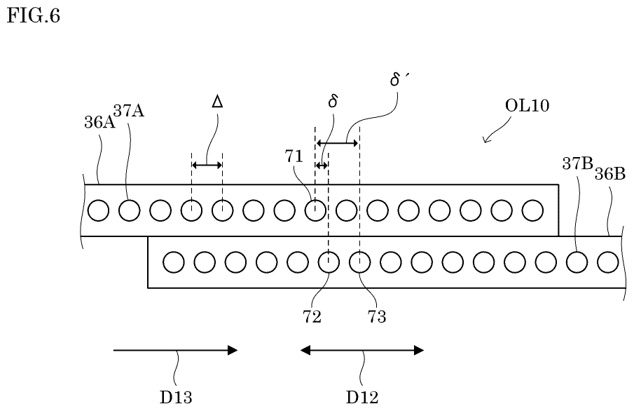

The acquisition processing portion 61 acquires a separation distance δ (see FIG. 6) (an example of a first separation distance according to the present disclosure) between a nozzle 71 (see FIG. 6) (an example of a third nozzle according to the present disclosure) and a nozzle 72 (see FIG. 6) (an example of a fourth nozzle according to the present disclosure) in the width direction D12, the nozzle 71 being included in an overlapping portion of the plurality of nozzles 37A with the plurality of nozzles 37B, the nozzle 72 being closest to the nozzle 71 out of the nozzles 37B positioned more on the specific direction D13 side than the nozzle 71.

The nozzle 71 is the nozzle 37A positioned most downstream in the specific direction D13 out of the nozzles 37A used for ejecting the ink in the recording head 36A. In other words, of the plurality of nozzles 37A, the nozzles 37A positioned more on the downstream side of the specific direction D13 than the nozzle 71 are not used for ejecting the ink.

For example, in the image forming apparatus 100, the separation distance δ measured during manufacturing of the image forming apparatus 100 is stored in the storage portion 6.

In this case, the acquisition processing portion 61 acquires the separation distance δ from the storage portion 6.

It is noted that the image forming apparatus 100 may include an image reading portion that reads an image formed on a sheet. In this case, the acquisition processing portion 61 may acquire the separation distance δ based on a result of reading the image formed on the sheet using the nozzles 71 and 72, by the image reading portion.

When the separation distance δ0 acquired by the acquisition processing portion 61 is equal to or larger than a predetermined threshold value, the first setting processing portion 62 sets the nozzles 37B positioned on the specific direction D13 side from the nozzle 72 out of the plurality of nozzles 37B as a usage area to be used for ejecting the ink. In this case, of the plurality of nozzles 37B, the nozzles 37B positioned more on the upstream side of the specific direction D13 than the nozzle 72 are not used for ejecting the ink.

Further, when the separation distance δ acquired by the acquisition processing portion 61 is smaller than the threshold value, the first setting processing portion 62 sets, as the usage area, the nozzles 37B positioned on the specific direction D13 side from a nozzle 73 (see FIG. 6) (an example of a fifth nozzle according to the present disclosure) adjacent to the nozzle 72 on the specific direction D13 side of the nozzle 72 out of the plurality of nozzles 37B.

The threshold value is a value set within a range that is larger than “0” and equal to or smaller than the nozzle interval Δ (see FIG. 6) between the recording head 36A and the recording head 36B. For example, the threshold value is set to a value equal to half the nozzle interval Δ, or the like.

When the separation distance δ acquired by the acquisition processing portion 61 is equal to or larger than the threshold value, the adjustment processing portion 63 reduces the ejection amount of the ink from either of the nozzle 71 and the nozzle 72 based on the separation distance δ.

In addition, when the separation distance δ acquired by the acquisition processing portion 61 is smaller than the threshold value, the adjustment processing portion 63 increases the ejection amount of the ink from either of the nozzle 71 and the nozzle 73 based on a separation distance δ′ (see FIG. 6) between the nozzle 71 and the nozzle 73 in the width direction D12 (an example of a second separation distance according to the present disclosure).

For example, when the separation distance δ acquired by the acquisition processing portion 61 is equal to or larger than the threshold value, the adjustment processing portion 63 reduces the ejection amount of the ink from either of the nozzle 71 and the nozzle 72 so that, when a dot area determined in accordance with a pixel gradation is represented by S, an area S′ of a dot formed by one of the nozzle 71 and nozzle 72 for which the ejection amount of the ink is to be reduced satisfies the following conditional expression (1).

$${S}^{′} = {S}^{*} δ / Δ \qquad ( 1 )$$

Furthermore, when the separation distance δ acquired by the acquisition processing portion 61 is smaller than the threshold value, the adjustment processing portion 63 increases the ejection amount of the ink from either of the nozzle 71 and the nozzle 73 so that the area S′ of the dot formed by one of the nozzle 71 and the nozzle 73 for which the ejection amount of the ink is to be increased satisfies the following conditional expression (2).

$${S}^{′} = {S}^{*} {δ}^{′} / Δ \qquad ( 2 )$$

The second setting processing portion 64 sets the threshold value based on a sheet type.

For example, in the image forming apparatus 100, table data indicating a correspondence relationship between the sheet type and the threshold value is stored in advance in the storage portion 6. In the table data, the correspondence relationship between the sheet type and the threshold value is determined such that the threshold value becomes smaller as a sheet becomes less susceptible to ink bleeding. This is because, as a sheet becomes less susceptible to ink bleeding, an upper limit distance between the nozzle 71 and the nozzle 73 at which a density can be corrected by increasing the ejection amount becomes smaller.

The second setting processing portion 64 sets the threshold value using the table data.

### [Ejection Amount Adjustment Processing]

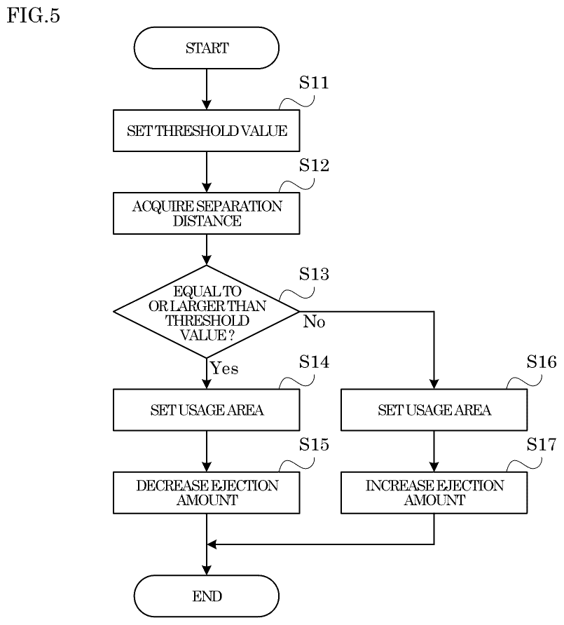

Hereinafter, with reference to FIG. 5, an adjustment method according to the present disclosure will be described along with exemplary procedures of ejection amount adjustment processing executed by the engine control portion 8. Herein, Step S11, Step S12, . . . represent numbers of processing procedures (steps) executed by the engine control portion 8. It is noted that when print processing for forming an image on a sheet is executed, the engine control portion 8 executes the ejection amount adjustment processing before executing the print processing.

### <Step S11>

First, in Step S11, the engine control portion 8 sets the threshold value. The processing of Step S11 is executed by the second setting processing portion 64 of the engine control portion 8.

Specifically, the engine control portion 8 acquires type information indicating a type of the sheet used to form an image in the print processing. The engine control portion 8 also acquires a value associated with the acquired type information in the table data. The engine control portion 8 then sets the acquired value as the threshold value.

### <Step S12>

In Step S12, the engine control portion 8 acquires the separation distance δ (see FIG. 6). The processing of Step S12 is an example of an acquisition step according to the present disclosure and is executed by the acquisition processing portion 61 of the engine control portion 8.

Specifically, the engine control portion 8 acquires the separation distance δ from the storage portion 6.

### <Step S13>

In Step S13, the engine control portion 8 determines whether or not the separation distance δ obtained by the processing of Step S12 is equal to or larger than the threshold value set by the processing of Step S11.

Herein, when determining that the separation distance δ is equal to or larger than the threshold value (Yes in S13), the engine control portion 8 shifts the processing to Step S14. On the other hand, when determining that the separation distance δ is not equal to or larger than the threshold value (No in S13), the engine control portion 8 shifts the processing to Step S16.

### <Step S14>

In Step S14, the engine control portion 8 sets the nozzles 37B positioned on the specific direction D13 side from the nozzle 72 (see FIG. 6) out of the plurality of nozzles 37B as the usage area. The processing of Step S14 is an example of a setting step according to the present disclosure and is executed by the first setting processing portion 62 of the engine control portion 8.

### <Step S15>

In Step S15, the engine control portion 8 reduces the ejection amount of the ink from the nozzle 71 based on the separation distance δ. The processing of Step S15 is an example of an adjustment step according to the present disclosure and is executed by the adjustment processing portion 63 of the engine control portion 8.

Specifically, the engine control portion 8 adjusts the ejection amount of the ink from the nozzle 71 so that the conditional expression (1) described above is satisfied. It is noted that the adjustment of the ejection amount of the ink from the nozzle 71 only needs to be realized by adjusting either one or both of a voltage and a waveform of a drive signal input to the piezoelectric element 39 corresponding to the nozzle 71.

### <Step S16>

In Step S16, the engine control portion 8 sets the nozzles 37B positioned on the specific direction D13 side from the nozzle 73 (see FIG. 6) out of the plurality of nozzles 37B as the usage area. The processing of Step S16 is an example of the setting step according to the present disclosure and is executed by the first setting processing portion 62 of the engine control portion 8.

<Step S17>

In Step S17, the engine control portion 8 increases the ejection amount of the ink from the nozzle 71 based on the separation distance δ′ (see FIG. 6). The processing of Step S17 is an example of the adjustment step according to the present disclosure and is executed by the adjustment processing portion 63 of the engine control portion 8.

Specifically, the engine control portion 8 adjusts the ejection amount of the ink from the nozzle 71 so that the conditional expression (2) described above is satisfied.

In this manner, in the image forming apparatus 100, when the separation distance δ is equal to or larger than the threshold value, the nozzles 37B positioned on the specific direction D13 side from the nozzle 72 out of the plurality of nozzles 37B are set as the usage area, and the ejection amount of the ink from the nozzle 71 is reduced based on the separation distance δ. Also in the image forming apparatus 100, when the separation distance δ is smaller than the threshold value, the nozzles 37B positioned on the specific direction D13 side from the nozzle 73 out of the plurality of nozzles 37B are set as the usage area, and the ejection amount of the ink from the nozzle 71 is increased based on the separation distance δ′. Thus, there is no need to provide the function of reducing the ejection amount of the ink from the nozzle 71 to be excessively small in preparation for the case where the separation distance δ is excessively small. Therefore, it is possible to suppress generation of a streak image without complicating the configuration.

It is noted that when the separation distance δ acquired by the acquisition processing portion 61 is equal to or larger than the threshold value, the adjustment processing portion 63 may decrease the ejection amount of the ink from both of the nozzle 71 and the nozzle 72 based on the separation distance δ.

In this case, the adjustment processing portion 63 only needs to decrease the ejection amount of the ink from both of the nozzle 71 and the nozzle 72 so that the area S′ of the dots formed by the nozzle 71 and the nozzle 72 satisfies the following conditional expression (3).

$${S}^{′} = {S}^{*} ( 1 + δ / Δ ) / 2 \qquad ( 3 )$$

Furthermore, when the separation distance δ acquired by the acquisition processing portion 61 is smaller than the threshold value, the adjustment processing portion 63 may increase the ejection amount of the ink from both of the nozzle 71 and the nozzle 73 based on the separation distance δ′.

In this case, the adjustment processing portion 63 only needs to increase the ejection amount of the ink from both of the nozzle 71 and the nozzle 73 so that the area S′ of the dots formed by the nozzle 71 and the nozzle 73 satisfies the following conditional expression (4).

$${S}^{′} = {S}^{*} ( 1 + {δ}^{′} / Δ ) / 2 \qquad ( 4 )$$

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: a first ejection portion which includes a plurality of first nozzles arranged along a width direction orthogonal to a conveying direction of a sheet, and causes ink to be ejected from each of the first nozzles; a second ejection portion which includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles; an acquisition processing portion which acquires a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle; a first setting processing portion which sets, when the first separation distance acquired by the acquisition processing portion is equal to or larger than a predetermined threshold value, the second nozzles positioned on the specific direction side from the fourth nozzle out of the plurality of second nozzles as a usage area to be used for ejecting the ink, and sets, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area; and an adjustment processing portion which decreases, when the first separation distance acquired by the acquisition processing portion is equal to or larger than the threshold value, an ejection amount of the ink of either one or both of the third nozzle and the fourth nozzle based on the first separation distance, and increases, when the first separation distance is smaller than the threshold value, the ejection amount of the ink of either one or both of the third nozzle and the fifth nozzle based on a second separation distance between the third nozzle and the fifth nozzle in the width direction.

### <Note 2>

The image forming apparatus according to note 1, in which the adjustment processing portion decreases, when the first separation distance acquired by the acquisition processing portion is equal to or larger than the threshold value, the ejection amount of the ink of either one of the third nozzle and the fourth nozzle based on the first separation distance, and increases, when the first separation distance is smaller than the threshold value, the ejection amount of the ink of either one of the third nozzle and the fifth nozzle based on the second separation distance, and when the first separation distance is smaller than the threshold value, the adjustment processing portion increases the ejection amount of the ink of either one of the third nozzle and the fifth nozzle so that, when a nozzle interval in the first ejection portion and the second ejection portion is represented by Δ, the second separation distance is represented by δ′, and a dot area determined in accordance with a pixel gradation is represented by S, an area S′ of a dot formed by one of the third nozzle and the fifth nozzle for which the ejection amount of the ink is to be increased satisfies a conditional expression (1) below.

$${S}^{′} = {S}^{*} {δ}^{′} / Δ \qquad ( 1 )$$

### <Note 3>

The image forming apparatus according to note 1, in which the adjustment processing portion decreases, when the first separation distance acquired by the acquisition processing portion is equal to or larger than the threshold value, the ejection amount of the ink of both of the third nozzle and the fourth nozzle based on the first separation distance, and increases, when the first separation distance is smaller than the threshold value, the ejection amount of the ink of both of the third nozzle and the fifth nozzle based on the second separation distance, and when the first separation distance is smaller than the threshold value, the adjustment processing portion increases the ejection amount of the ink of both of the third nozzle and the fifth nozzle so that, when a nozzle interval in the first ejection portion and the second ejection portion is represented by Δ, the second separation distance is represented by δ′, and a dot area determined in accordance with a pixel gradation is represented by S, an area S′ of each of dots formed by the third nozzle and the fifth nozzle satisfies a conditional expression (2) below.

$${S}^{′} = {S}^{*} ( 1 + {δ}^{′} / Δ ) / 2 \qquad ( 2 )$$

### <Note 4>

The image forming apparatus according to any one of notes 1 to 3, including: a second setting processing portion which sets the threshold value based on a type of the sheet.

### <Note 5>

An adjustment method executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles, the adjustment method including: an acquisition step of acquiring a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle; a setting step of setting, when the first separation distance acquired in the acquisition step is equal to or larger than a predetermined threshold value, the second nozzles positioned on the specific direction side from the fourth nozzle out of the plurality of second nozzles as a usage area to be used for ejecting the ink, and setting, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area; and an adjustment step of decreasing, when the first separation distance acquired in the acquisition step is equal to or larger than the threshold value, an ejection amount of the ink of either one or both of the third nozzle and the fourth nozzle based on the first separation distance, and increasing, when the first separation distance is smaller than the threshold value, the ejection amount of the ink of either one or both of the third nozzle and the fifth nozzle based on a second separation distance between the third nozzle and the fifth nozzle in the width direction.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a first ejection portion which includes a plurality of first nozzles arranged along a width direction orthogonal to a conveying direction of a sheet, and causes ink to be ejected from each of the first nozzles;
a second ejection portion which includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles;
an acquisition processing portion which acquires a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle;
a first setting processing portion which sets, when the first separation distance acquired by the acquisition processing portion is equal to or larger than a predetermined threshold value, the second nozzles positioned on the specific direction side from the fourth nozzle out of the plurality of second nozzles as a usage area to be used for ejecting the ink, and sets, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area; and
an adjustment processing portion which decreases, when the first separation distance acquired by the acquisition processing portion is equal to or larger than the threshold value, an ejection amount of the ink of either one or both of the third nozzle and the fourth nozzle based on the first separation distance, and increases, when the first separation distance is smaller than the threshold value, the ejection amount of the ink of either one or both of the third nozzle and the fifth nozzle based on a second separation distance between the third nozzle and the fifth nozzle in the width direction.

2. The image forming apparatus according to claim 1, wherein
the adjustment processing portion decreases, when the first separation distance acquired by the acquisition processing portion is equal to or larger than the threshold value, the ejection amount of the ink of either one of the third nozzle and the fourth nozzle based on the first separation distance, and increases, when the first separation distance is smaller than the threshold value, the ejection amount of the ink of either one of the third nozzle and the fifth nozzle based on the second separation distance, and
when the first separation distance is smaller than the threshold value, the adjustment processing portion increases the ejection amount of the ink of either one of the third nozzle and the fifth nozzle so that, when a nozzle interval in the first ejection portion and the second ejection portion is represented by Δ, the second separation distance is represented by δ′, and a dot area determined in accordance with a pixel gradation is represented by S, an area S′ of a dot formed by one of the third nozzle and the fifth nozzle for which the ejection amount of the ink is to be increased satisfies a conditional expression (1) below.
$${S}^{′} = {S}^{*} {δ}^{′} / Δ \qquad ( 1 )$$

3. The image forming apparatus according to claim 1, wherein
the adjustment processing portion decreases, when the first separation distance acquired by the acquisition processing portion is equal to or larger than the threshold value, the ejection amount of the ink of both of the third nozzle and the fourth nozzle based on the first separation distance, and increases, when the first separation distance is smaller than the threshold value, the ejection amount of the ink of both of the third nozzle and the fifth nozzle based on the second separation distance, and
when the first separation distance is smaller than the threshold value, the adjustment processing portion increases the ejection amount of the ink of both of the third nozzle and the fifth nozzle so that, when a nozzle interval in the first ejection portion and the second ejection portion is represented by Δ, the second separation distance is represented by δ′, and a dot area determined in accordance with a pixel gradation is represented by S, an area S′ of each of dots formed by the third nozzle and the fifth nozzle satisfies a conditional expression (2) below.
$${S}^{′} = {S}^{*} ( 1 + {δ}^{′} / Δ ) / 2 \qquad ( 2 )$$

4. The image forming apparatus according to claim 1, comprising:
a second setting processing portion which sets the threshold value based on a type of the sheet.

5. An adjustment method executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction at a position that is more on a specific direction side along the width direction than the first ejection portion, and causes the ink to be ejected from each of the second nozzles, the adjustment method comprising:
an acquisition step of acquiring a first separation distance between a third nozzle and a fourth nozzle in the width direction, the third nozzle being included in an overlapping portion of the plurality of first nozzles with the plurality of second nozzles, the fourth nozzle being closest to the third nozzle out of the second nozzles positioned more on the specific direction side than the third nozzle;
a setting step of setting, when the first separation distance acquired in the acquisition step is equal to or larger than a predetermined threshold value, the second nozzles positioned on the specific direction side from the fourth nozzle out of the plurality of second nozzles as a usage area to be used for ejecting the ink, and setting, when the first separation distance is smaller than the threshold value, the second nozzles positioned on the specific direction side from a fifth nozzle adjacent to the fourth nozzle on the specific direction side of the fourth nozzle out of the plurality of second nozzles as the usage area; and
an adjustment step of decreasing, when the first separation distance acquired in the acquisition step is equal to or larger than the threshold value, an ejection amount of the ink of either one or both of the third nozzle and the fourth nozzle based on the first separation distance, and increasing, when the first separation distance is smaller than the threshold value, the ejection amount of the ink of either one or both of the third nozzle and the fifth nozzle based on a second separation distance between the third nozzle and the fifth nozzle in the width direction.
